(19) United States
(12) Patent Application Publication
(10) Pub. No.: US 2016/0295187 A1
(43) Pub. Date: Oct. 6, 2016

(54) INFORMATION PROCESSING DEVICE AND PROJECTION APPARATUS

(71) Applicant: KABUSHIKI KAISHA TOSHIBA, Tokyo (JP)

(72) Inventors: Yuma SANO, Kawasaki (JP); Hisashi KOBIKI, Kawasaki (JP); Wataru WATANABE, Kawasaki (JP); Masahiro BABA, Yokohama (JP)

(73) Assignee: KABUSHIKI KAISHA TOSHIBA, Tokyo (JP)

(21) Appl. No.: 15/008,807

(22) Filed: Jan. 28, 2016

(30) Foreign Application Priority Data
Mar. 30, 2015 (JP) 2015-070389

(51) Int. Cl. H04N 9/31

(52) U.S. Cl. CPC H04N 9/3194; H04N 9/3185

(57) ABSTRACT

An information processing device connected to a projection unit comprising a shape acquiring unit, an observation point acquiring unit, an evaluating unit, and a generating unit. The shape acquiring unit is configured to acquire shape information regarding a projection plane onto which an image is projected by the projection unit and projection point information regarding a position of the projection unit. The observation point acquiring unit is configured to acquire observation point information regarding an observation point to observe the projection plane. The evaluating unit is configured to evaluate an appropriate level of the projection plane based on the shape information, the projection point information, and the observation point information. The generating unit is configured to generate an auxiliary information data based on the appropriate level.

### CROSS-REFERENCE TO RELATED APPLICATIONS

This application is based upon and claims the benefit of priority from Japanese Patent Application No. 2015-070389, filed Mar. 30, 2015, the entire contents of which are incorporated herein by reference.

### FIELD

Embodiments described herein relate generally to an information processing device and a projection apparatus.

### BACKGROUND

Image projection apparatus may include a projector that projects an image onto a projection plane. It is sometimes difficult for users to decide where to install an image projection apparatus so as to project an image appropriately with minimal distortion. Several techniques have been developed to assist users with tars task. For example, there has been known a technique to evaluate a reproduction level of an image by comparing a desired image to be projected onto the projection plane with an actual image on the projection plane picked up with an imaging means such as a camera or other imager. However it is sometimes difficult to evaluate an appropriate level of an image observed from the position of the imaging means, which may be at a point or area distant from the projection plane.

### BRIEF DESCRIPTION OF THE DRAWINGS

FIG. 1 is a block diagram of an image projection apparatus according to a first embodiment.

FIG. 2 is a flow chart of an information processing method according to the first embodiment.

FIG. 3 is a schematic perspective diagram showing an example of a distance sensor.

FIG. 4A is a diagram of a coordinate system and coordinate of a pixel in a projection image.

FIG. 4B is a diagram of a coordinate system and coordinate of a pixel in a receiving image.

FIG. 4C is a diagram of a schematic view showing a positional relationship between a projection unit, a receiving unit, and an object.

FIG. 5A is a schematic prospective diagram of an example image projection apparatus.

FIG. 5B is a diagram of an example image displayed on a display.

FIG. 6A is a schematic diagram showing a positional relationship between a projection plane and an output image and an input image.

FIG. 6B is a schematic diagram of an output image.

FIG. 6C is a schematic diagram of an observation image.

FIG. 7A is a schematic plane diagram of a lens and a display element which has a center being on a light axis of the lens.

FIG. 73 is a schematic plane view of a lens and a display element that has a center not being on a light axis of the lens.

FIG. 8 is a diagram of a coordinate system and external parameters R_{P} and t_{P}.

FIG. 9A is a schematic diagram of a positional relationship between a projection plane, a projection point, and an observation point.

FIG. 9B is a schematic diagram showing another positional relationship between a projection plane, a projection point, and an observation point.

FIG. 10A shows an example of auxiliary information according to the first embodiment.

FIG. 10B shows another example of auxiliary information according to the first embodiment.

FIG. 10C shows another example of auxiliary information according to the first embodiment.

FIG. 10D shows another example of auxiliary information according to the first embodiment.

FIG. 10E shows another example of auxiliary information according to the first embodiment.

FIG. 11 shows an example of an output image comprising a plurality of small regions.

FIG. 12A shows an example of an output image according to a second embodiment.

FIG. 12B shows an example of an output image according to a second embodiment.

FIG. 13A is a schematic diagram showing a positional relationship between a projection unit, an imaging apparatus, and a projection plane.

FIG. 13B is a schematic diagram showing a positional relationship between a projection unit, an imaging apparatus, and a projection plane.

FIG. 14 is a block diagram of an image projection apparatus according to a third embodiment.

FIG. 15 is a flow chart of an information processing method according to the third embodiment.

FIG. 16 is a block diagram of an image projection apparatus according to a fourth embodiment.

FIG. 17 is a schematic perspective diagram of an image projection apparatus according to the fourth embodiment.

### DETAILED DESCRIPTION

Each of the embodiments will now be described in detail with reference to the accompanying drawings.

Note that the figures are conceptual pattern diagrams, and the relationships between thicknesses and widths and ratios of size of each part are not necessarily represented to scale. Moreover, the size and ratio of components that appear in multiple figures are not necessarily to scale, or the same in each figure.

According to one embodiment, an information processing device connected to a projection unit comprises a shape acquiring unit, an observation point acquiring unit, an evaluating unit, and a generating unit. The shape acquiring unit is configured to acquire shape information regarding a projection plane onto which an image is projected by the projection unit and projection point information regarding a position of the projection unit. The observation point acquiring unit is configured to acquire observation point information regarding an observation point to observe the projection plane. The evaluating unit is configured to evaluate an appropriate level of the projection plane based on the shape information, the projection point information, and the observation point information. The generating unit is configured to generate an auxiliary information data based on the appropriate level.

According to one embodiment, a projection apparatus comprises a projection unit and the information processing device.

### First Embodiment

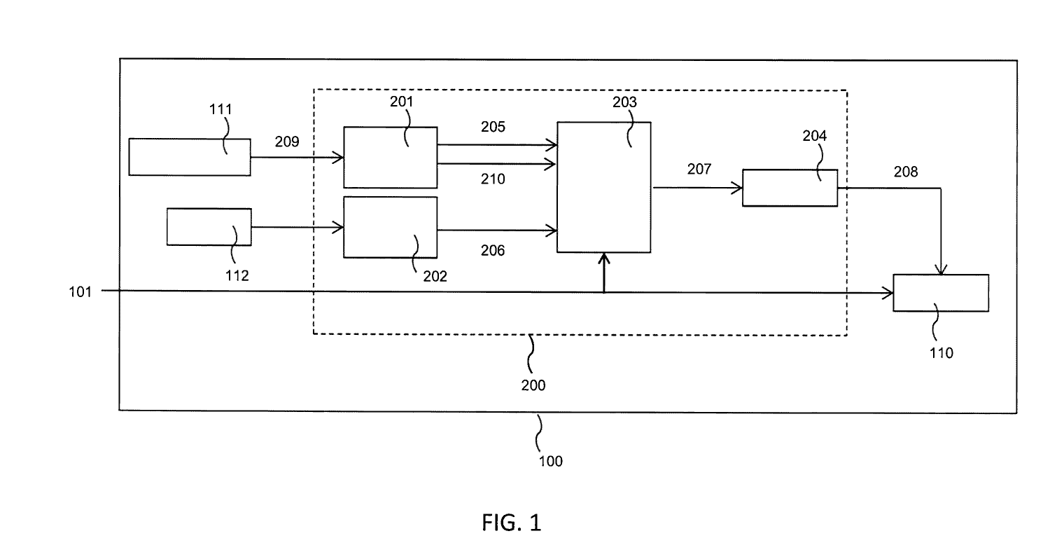

FIG. 1 is a block diagram of an image projection apparatus (a projection apparatus) according to a first embodiment. It should be noted that the block diagram of FIG. 1 is an example of a projection apparatus of this embodiment and not intended to depict the details of an actual projection apparatus.

The image projection apparatus 100 comprises an information processing device 200, a projection unit 110, a distance sensor 111, and an input unit 112. The information processing device 200 comprises an evaluating unit 203, and a generating unit 204, The information processing device 200 further comprises a shape acquiring unit 201, and an observation point acquiring unit 202.

The information processing device 200 may be, for example, an IC (integrated circuit) such as an ASIC (Application Specific Integrated Circuit), FPGA (Field Programmable Gate Array), an electric circuit such as a CPU (Central Processing Unit), or an MPU (Micro Processing Unit). The information processing device 200 may be implemented, in whole or in part, using an IC such as an LSI (Large Scale integration) or IC chip set. The IC may be a special-purpose processor or general-purpose processor. Some or all of the blocks in FIG. 1 may be implemented using a processor or processors.

The information processing device 200 may be in a housing with the projection unit 110, the distance sensor 111, and the input unit 112 or in a housing separated from, another housing in which the projection unit 110, the distance sensor 111, and the input unit 112 are located. The information processing device 200 may be connected to the projection unit 110 directly or indirectly. The data from the information processing device 200 may be, for example, transmitted to the projection unit 110 by wire or by a wireless interface.

The image projection apparatus 100 is set so that the projection unit 110 faces a projection plane. The projection plane is a plane of an object that faces the image projection apparatus 100.

An input image data 101 is converted to an output data image by the generating unit 204 and the output data image is projected onto the projection plane by the projection unit 110. A process for selecting an appropriate projection plane onto which an output image is projected will now be described.

The distance sensor 111 measures a distance between the distance sensor 111 and the projection plane and transmits distance information 209 acquired during the measurement step to the shape acquiring unit 201.

The shape acquiring unit 201 acquires information regarding a three dimensional shape of the projection plane (shape information 205) and information regarding a position of the image projection apparatus 100 (projection point information 210) from the distance information 203. The shape acquiring unit 201 transmits the shape information 205 and the projection point information 210 to the evaluating unit 203.

The shape information 205 may be, for example, information regarding asperity of a projection plane or three dimensional coordinates of points on the projection plane. The projection point information 210 may be, for example, information regarding relative positions between the projection plane and the image projection apparatus 100. The projection point information 210 may be, for example, information regarding a coordinate of the position of the image projection apparatus 100 within a coordinate system.

The observation point acquiring unit 202 may be connected to the input unit 112. The observation point acquiring unit 202 acquires information regarding an observation point for observing the project plane (observation point information) 206 input by the user via the input unit 112. The observation point acquiring unit 202 transmits the observation point information 206 to the evaluating unit 203. The observation point information 206 may be, for example, information regarding relative positions between the image projection apparatus 100 and the observation point or between the projection plane and the observation point. The observation point information 206 may be, for example, information regarding a coordinate of the position of the observation point on a coordinate system.

The input image data 101 is transmitted to the evaluating unit 203. In one embodiment, the numbers of pixels along horizontal direction and vertical direction of the input image data 101 are included in the input image data 101 and transmitted to the evaluating unit 203.

The evaluating unit 203 evaluates whether the projecting plane is appropriate. For example, the evaluating unit may evaluate whether the one or more parameters of the projecting plane meet an appropriate level 207. The appropriate level may be evaluated, for example, based on at least one of (i) a positional shift between the image estimated to be observed from the observation point, in the case the output image is projected onto the projection plane (an estimated image), and the output image, and (ii) deficit information (such as information regarding image distortion and/or deficit). The evaluating unit 203 transmits the appropriate level 207 to the generating unit 204.

The estimated image is acquired with the shape information 205, the projection point information 210, the observation point information 206, and the input image data 101 by the evaluating unit 203. That is, the estimated image is the image acquired by estimating the image to be observed from the observation point (an observation image) in the case the output image is projected onto the projection plane.

A position gap may be, for example, a gap between a position of a point in the estimated image and a position of a point in the output image which corresponds to the point in the estimated image. A deficit means that there is no point in the estimated image which corresponds to the point in the output image. The less the positional shift and the deficit in the estimated image is, the larger the appropriate level 207 is.

The generating unit 204 generates auxiliary information data 208 for informing the user of the appropriate level 207. For example, the appropriate level 207 may be included in the auxiliary information data 208. The auxiliary information data 208 may include, for example, a predetermined region in the projection plane and the appropriate level 207 in the predetermined region.

Processing of the information processing device 200 will new be described.

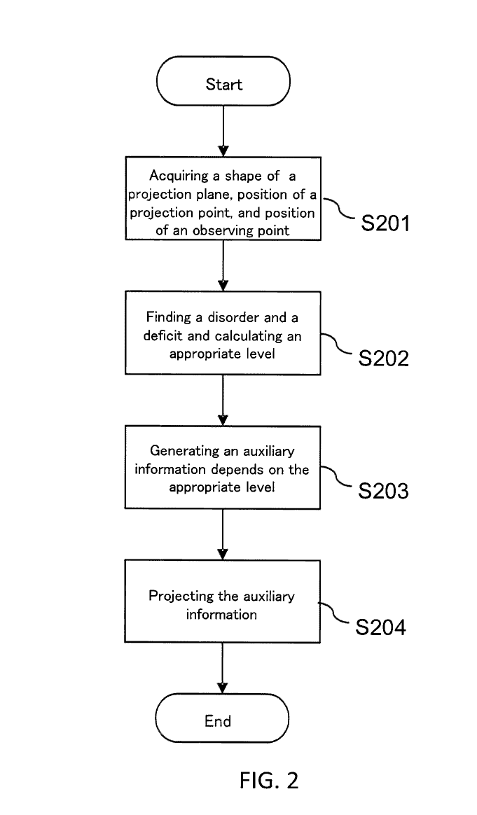

FIG. 2 is a flow chart of an information processing method according to the first embodiment. The shape acquiring unit 201 acquires the shape information 205 and the projection point information 210 and transmits the shape information 205 and the projection point information 210 to the evaluating unit 203. The observation point acquiring unit 202 acquires the observation point information 206 and transmits the observation point information 206 to the evaluating unit 203 (S201).

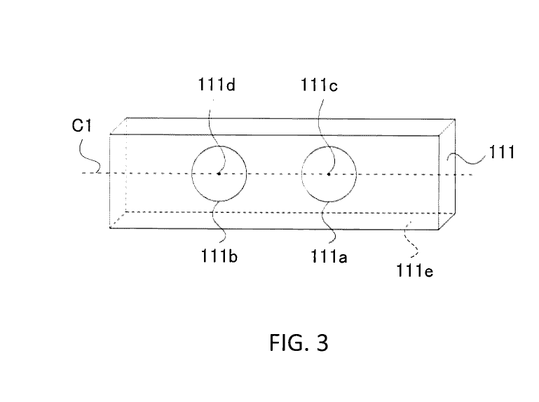

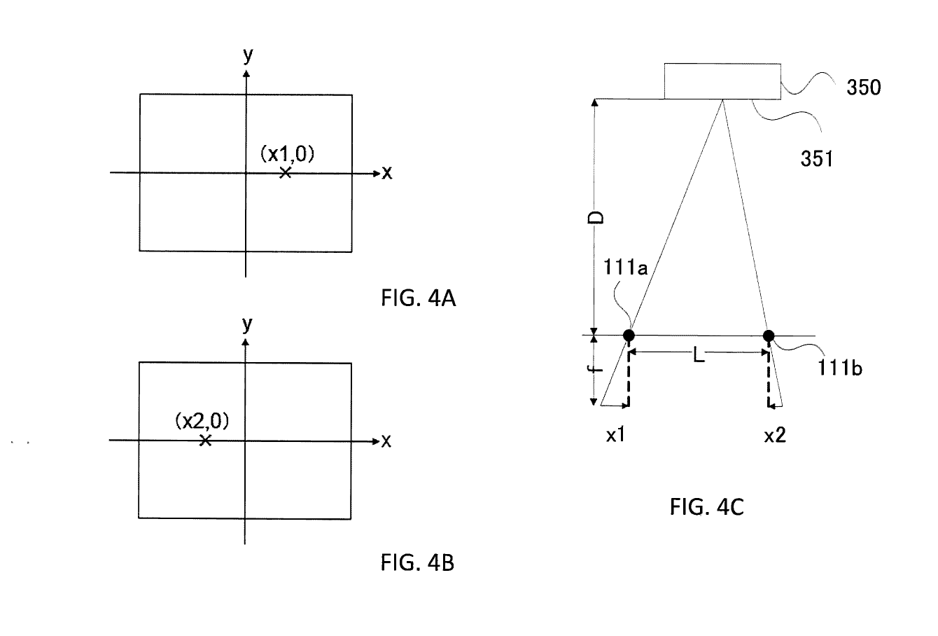

The distance sensor 111 and the shape acquiring unit 201 will now be described. FIG. 3 is a schematic perspective diagram of an example of the distance sensor 111. FIGS. 4A-4C are schematic plane diagrams to explain a method of calculating three dimensional coordinates of the projection image. FIG. 4A is a diagram of a coordinate system and coordinates of a pixel in a projection image. FIG. 4B is a diagram of a coordinate system and coordinates of a pixel in a receiving image. FIG. 4C is a diagram of a schematic view of a positional relationship between a projection unit, a receiving unit, and the object.

The object 350 has a projection plane 351. The distance sensor 111 measures the distance between the distance sensor 111 itself and the projection plane 351 and transmits the observation point information regarding the distance (a distance information) 209 to the shape acquiring unit 201. The shape acquiring unit 201 acquires the shape information 205 of projection plane 351 and the projection point information 210 based on the distance information 203 and transmits the shape information 205 and the projection point information 210 to the evaluating unit 203.

The distance sensor 111 may comprise a projection unit 111a and a receiving unit 111b. The projection unit 111a and the receiving unit 111b may be at almost same height from the ground. For example, a line segment C1 connecting the center 111c of the projection unit 111a and the center 111d of the receiving unit 111b may be almost parallel to the bottom face 111e of the distance sensor 111. Therefore the line segment C1 is horizontal in the case where the distance sensor 111 is provided on a horizontal plane.

The projection unit 111a may, for example, project infrared light which has a random pattern onto the projection plane 351. The receiving unit 111b may receive a part of the infrared light reflected by the projection plane 351.

The case where the pattern of infrared light projected by the projection unit 111a and the pattern of infrared light received by the receiving unit 111b are two dimensional images will now be described. The coordinates of a point in the receiving image corresponding to the coordinates (xp, yp) of a pixel in the projection image is defined as (xc, yc). The shape acquiring unit 201 may find coordinates (Xs, Ys, Zs) of a three dimensional shape of the projection plane 351 by finding the coordinates (xc, yc) of a pixel in the receiving image corresponding to the coordinates (xp, yp) of a pixel in the projection image as follows:

In FIG. 4A and 4B, the case where the coordinates of a pixel in the receiving image corresponding to the coordinates (x1,0) of a pixel in the projection image (X2, 0) is described.

An example of positional relationship between the projection unit 111a, the receiving unit 111b, and the object 350 is described in FIG. 4C. L is defined as a physical distance between the projection unit 111a and the receiving unit 111b. D is defined as a physical distance between the distance sensor 111 and the object 350. f is a focal length of the receiving unit 111b. Relation (1) is established by the geometric relations.

$$\frac{D}{L} = \frac{f}{( x 1 - x 2 )} \qquad ( 1 )$$

The distance D between the distance sensor 111 and the object 350 is defined by relation (2).

$$D = \frac{f \cdot L}{( x 1 - x 2 )} \qquad ( 2 )$$

The coordinates (Xs, Ys, Zs) of a three dimensional shape of the projection plane 351 are defined by relations

$$\begin{matrix}{X}_{s} = \frac{x 1}{f} D = \frac{x 2}{f} D & ( 3 ) \\ {Y}_{s} = \frac{{y}_{c}}{f} D = 0 & ( 4 ) \\ {Z}_{s} = D = \frac{f \cdot L}{( x 1 - x 2 )} & ( 5 )\end{matrix}$$

where y_{c} is a y-coordinate of the pixel in the receiving image.

The light that the projection unit 111a projects and the light the receiving unit 111b receives may be visible light. Alternatively, the light may be invisible light, such as infrared (IR) or ultraviolet (UV) light.

An image unit may be used for means to measure a distance instead of the distance sensor 111. In this case, the projection unit 110 projects light in a predetermined pattern onto the object 350. The image unit may take an image on the object 350. The distance information between the image unit and the object 350 may be acquired based on the corresponding relation between the image taken by the image unit and the pattern projected onto the object 350 by the projection unit 110.

A plurality of image units may be used instead of a distance sensor 111. In this case, the image projection apparatus 100 may acquire the distance between the image units and the object 350 based on the corresponding relationship between pixels in a plurality of images taken by the plurality of imaging units. For example, the distance between the line connecting two imaging units and object 350 may be acquired.

The method by which the distance is measured by the distance sensor 111 is not limited to the above-described method involving the projection of light which has a predetermined pattern. For example, the distance sensor 111 may project light modulated by a pulse shape onto the projection plane and receive the light refracted by the projection plane 351, and measure the distance between the distance sensor 111 and the projection plane 351 based on the difference between the phase of the projected light and the received light. In this way, the distance sensor 111 is an example of a means to acquire the three dimensional shape of the projection plane 351 no be projected an image by the projection unit 110. However, such means to acquire the three dimensional shape of the projection plane 351 are not limited to the means described above.

For example, the three dimensional shape of the projection plane 351 may be determined with reference to the position of the receiving unit 111b of the distance sensor 111 as an origin. Therefore the coordinates of a projection point (the projection unit 110) may be set based on the distance between the receiving unit 111b of the distance sensor 111 and the projection unit 110. For example, in the case where receiving unit 111b may be located in the X direction at px, in the Y direction at py, and in the Z direction at pz apart from the projection unit 110, the coordinates of the projection point (Xp, Yp, Zp) may be defined as (px, py, pz). The shape acquiring unit 201 acquires the shape information 205 of the projection plane and transmits the shape information 205 to the evaluating unit 203 with the projection point information 210.

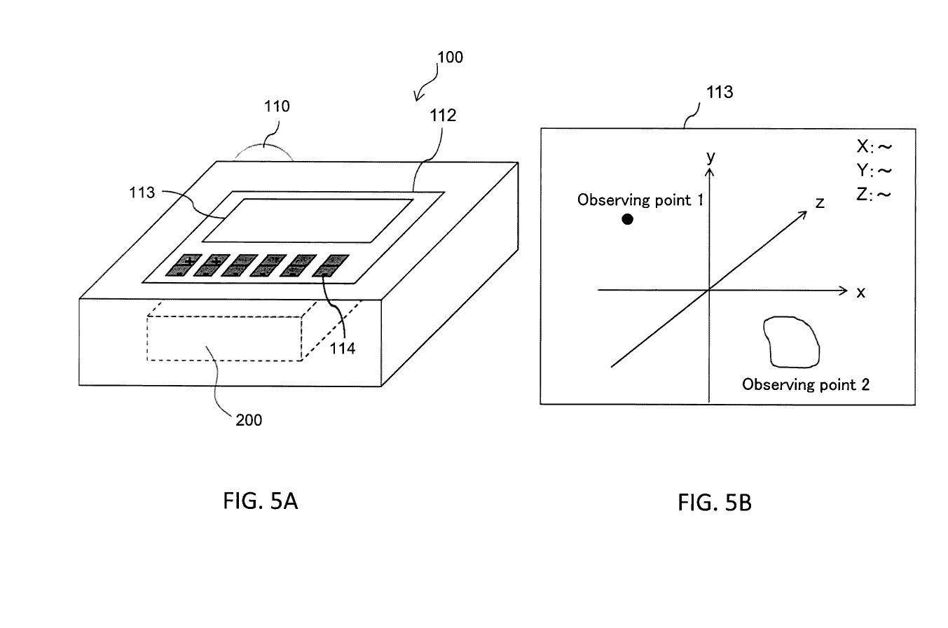

The observation point acquiring unit 202 acquires the observation point information 206 and transmits the observation point information 206 to the evaluating unit 203. FIG. 5A is a schematic prospective diagram of an example of an image projection apparatus. In this embodiment the input unit 112 is in a housing in which the information processing device 200 is located. The input unit 112 may, for example, include a display 113 and an operating unit 114. The operating unit 114 may include, for example, one or more switches or buttons (including, for example, soft buttons). A user may, for example, input the coordinate of a position of an observation point with the operating unit 114.

FIG. 5B is a diagram of an example of an image displayed on a display. The display 113 displays, for example, information for a user to input the observation point information 206. The display 113 displays, for example, a position of the projection point and a position of the observation point.

For example, a coordinate system, which has a 2 direction parallel to the projection direction, of the projection unit 110, a X direction perpendicular to the Z direction, and a Y direction perpendicular to the X direction and Z direction may be displayed on the display 113 before a user inputs a position of an observation point. A user may input a position of an observation point in the coordinate system with the operating unit 114. After inputting, the position of the observation point in the coordinate system may be displayed on the display 113.

The observation point information 206 may include information regarding an area that includes the observation point instead of information regarding the position of the observation point. The area of the observation point may be an area defined based on a reference observation point. By inputting a reference observation point and a length, the area of observation point which has center on the reference observation point and semi diameter of the length may be defined. The area of observation point may be displayed on the display 113, instead of the position of the reference observation point.

In some embodiments, the input unit 112 may be separate from a housing in which the information processing device 200 is located. The input unit 112 may be, for example, implemented on a tablet device or personal computer (PC), or other type of remote control.

For example, the input unit 112 may comprise a touch panel or touchscreen. By touching the touch panel, the coordinate system displayed on the touch panel may be rotate, A user may set a position of an observation point, or an area of an observing area by touching the corresponding area of the touch panel. In the case where an area of observation point is set, the observation point acquiring unit 202 may use the center of the area or the center of gravity of the area as a reference observation point.

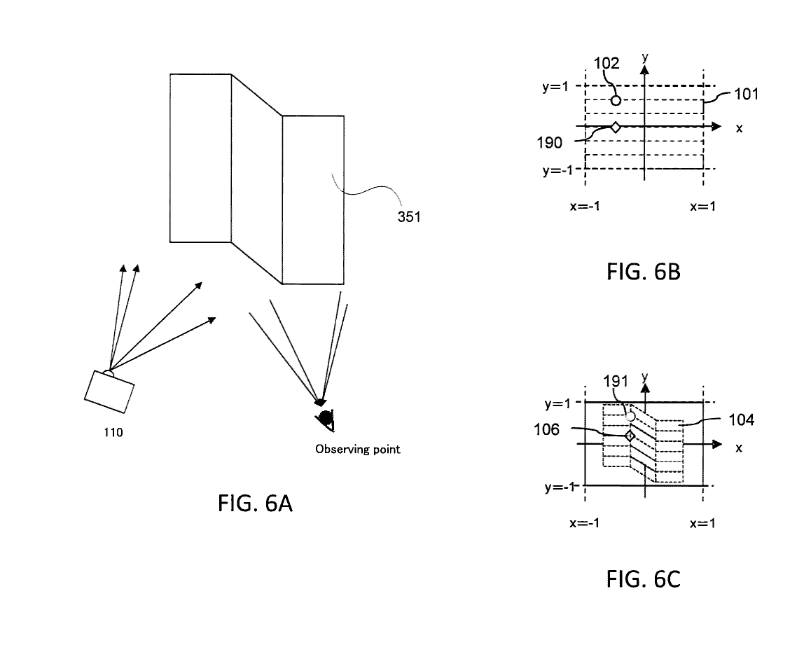

The evaluating unit 203 acquires the appropriate level 207 and transmits the appropriate level 207 to the generating unit 204 (S202). An exemplary method of acquiring the appropriate level 207 will be described with reference to FIGS. 6A-9. An output image that is acquired by the input image data 101 may not include auxiliary information.

FIG. 6A is a schematic diagram of a positional relationship between a projection plane and an output image and an input image. FIG. 6B is a schematic diagram of the output image. FIG. 6C is a schematic diagram of an observation image.

The evaluating unit 203 finds a point on the projection plane 351 and a pixel in the output image corresponds to the point on the projection plane in the case where the output image is projected onto the project plane by the projection unit 110. The pixel in the output image may be, for example, represented by a coordinate system, having reference to the output image.

In FIG. 6B and 6C, an X axis and a Y axis are defined so that the origin is on the center of the input image and the output image. The coordinate systems of the input image and the output image are set so that the minimum value of the X-coordinate is −1, the maximum value of the X-coordinate is 1, the minimum value of the Y-coordinate is −1, the maximum value of the Y-coordinate is 1.

A coordinate mP of a pixel in the output image is defined as (xp, yp). The three dimensional coordinate M of a point on the projection plane 351 corresponding to the pixel is defined as (Xₛ, Yₛ, Zₛ) in the case that the output image is projected onto the projection plane 351. The relationship between the coordinate mp of a pixel in the output image and the three dimensional coordinate M of the point on the projection plane 351 is as follows;

\tilde{m}ₚ=P_{P}·\tilde{M} (6)

where \tilde{m}ₚ is a homogeneous coordinate of mₚ and \tilde{M} is a homogeneous coordinate of M.

Pp represents a perspective projection matrix for an image projected onto the projection plane 351 by the projection unit 110, That is, the evaluating unit 203 transforms the perspective projection in the process of finding the coordinates of the pixel in the output image corresponding to the point of the three dimensional coordinates in the projection plane 351. The perspective projection matrix Pₚ is represented by an internal parameter Aₚ, and external parameters Rₚ, and tₚ.

Pₚ=A_{P}·[R_{P}·t_{P}] (7)

The internal parameter Aₚ may indicate, for example, characteristic of the projection unit 110. For example, the internal parameter Aₚ may be defined based on the focal length of a lens of the projection unit 110 and the position (the coordinates) of the center of a display element for the light axis of the lens of the projection unit 110.

The external parameters Rₚ, and tₚ may indicate, for example, the position of the projection unit 110 and attitude of the projection unit 110. For example, the external parameters Rₚ, and tₚ may be defined based on the position of the projection unit 110 for the origin set arbitrarily in the three dimensional space and the direction in which an image is projected by the projection unit 110.

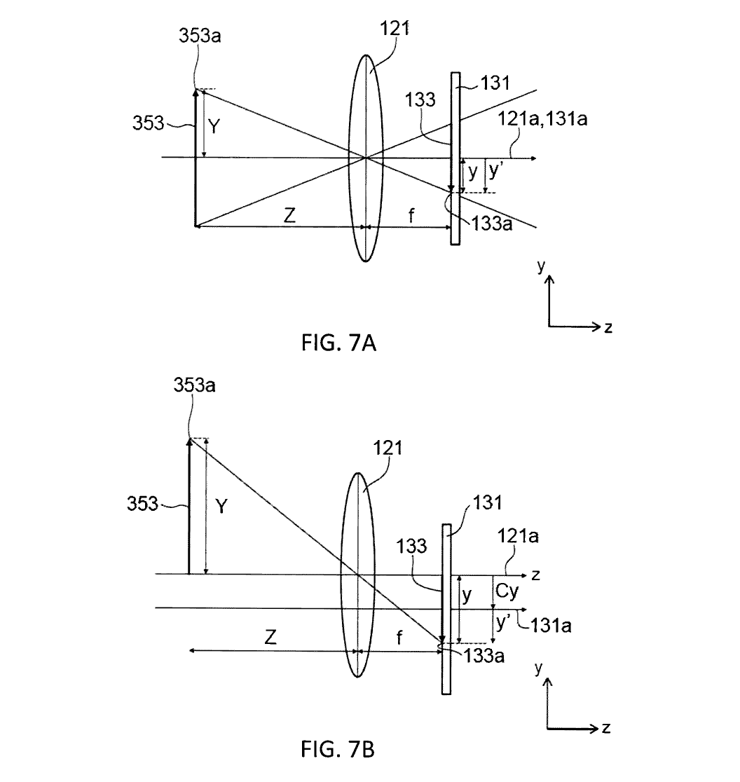

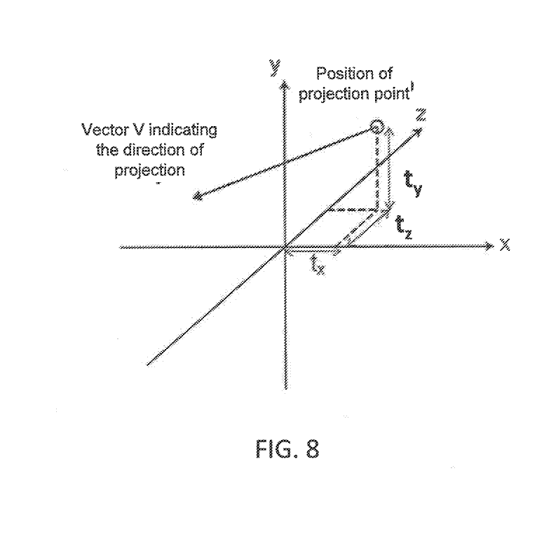

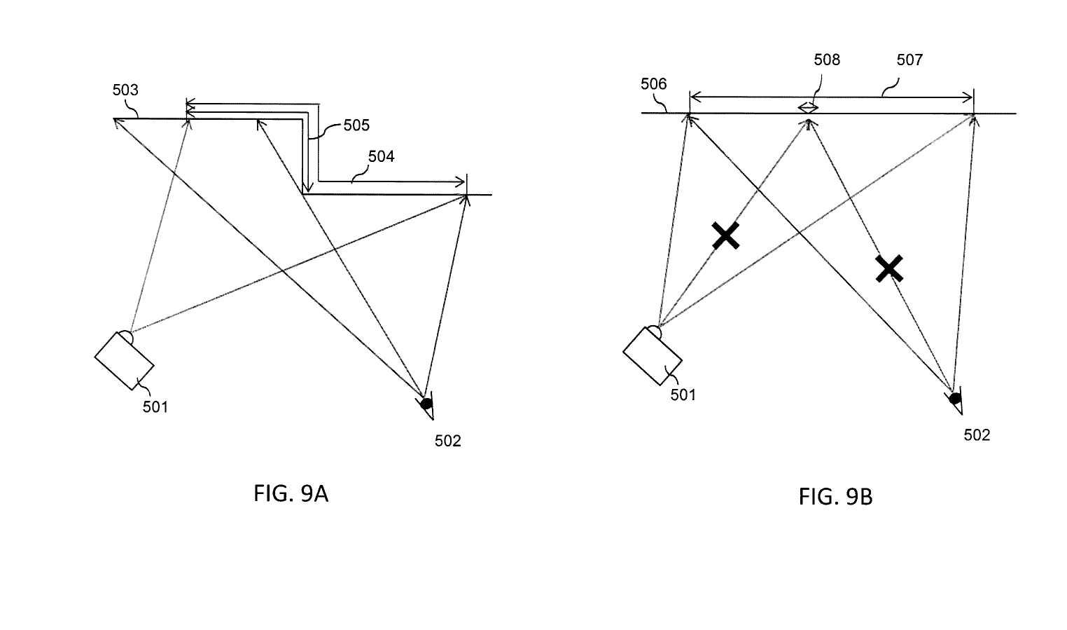

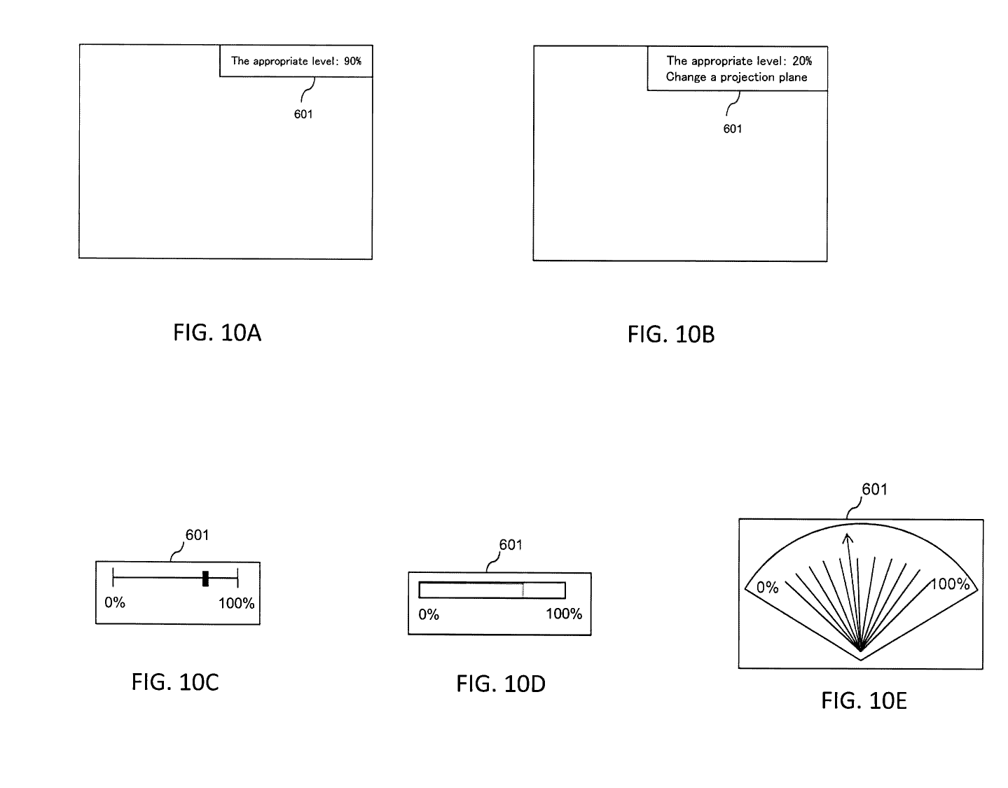

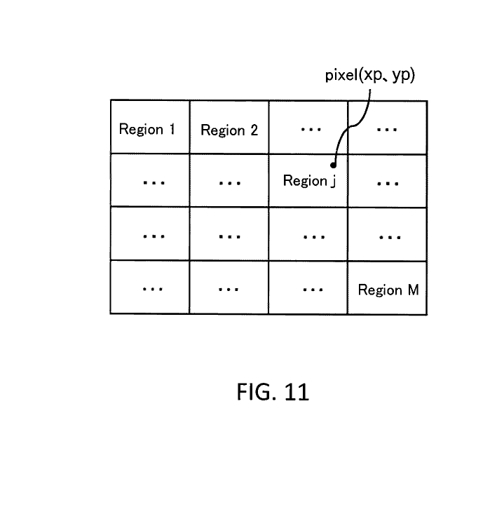

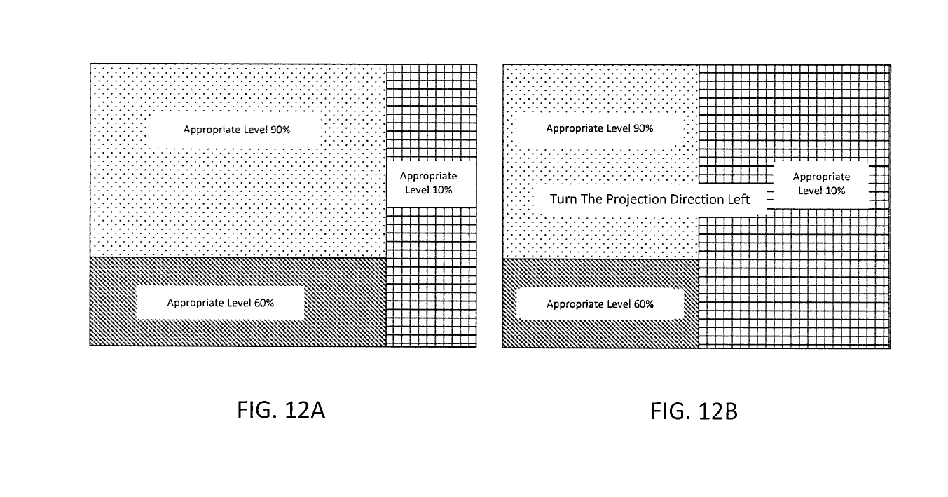

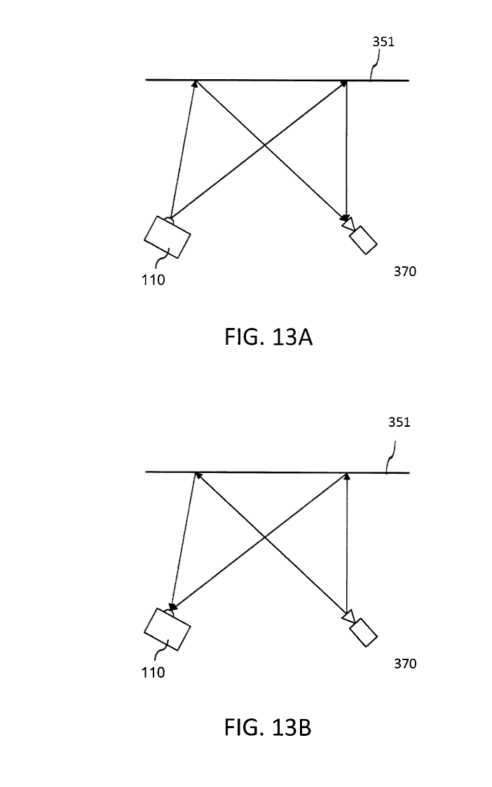

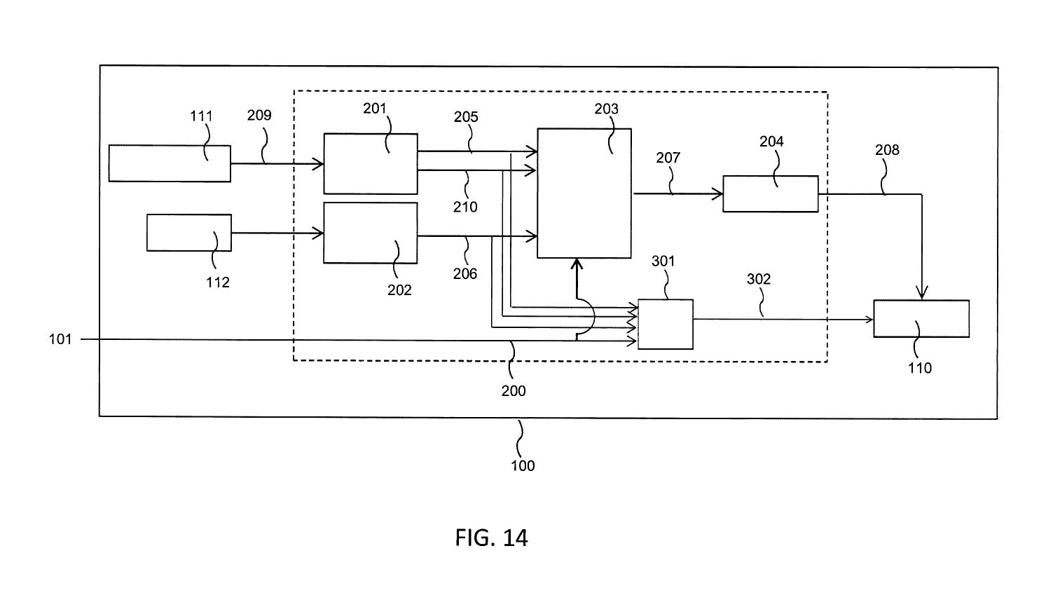

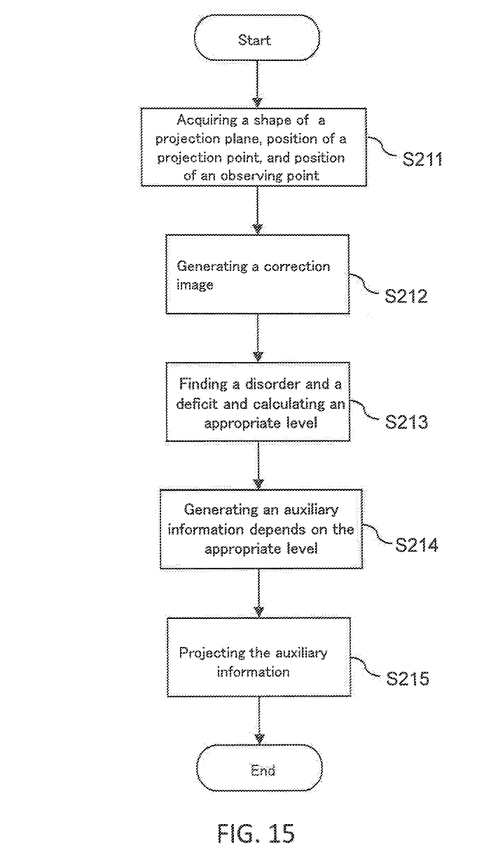

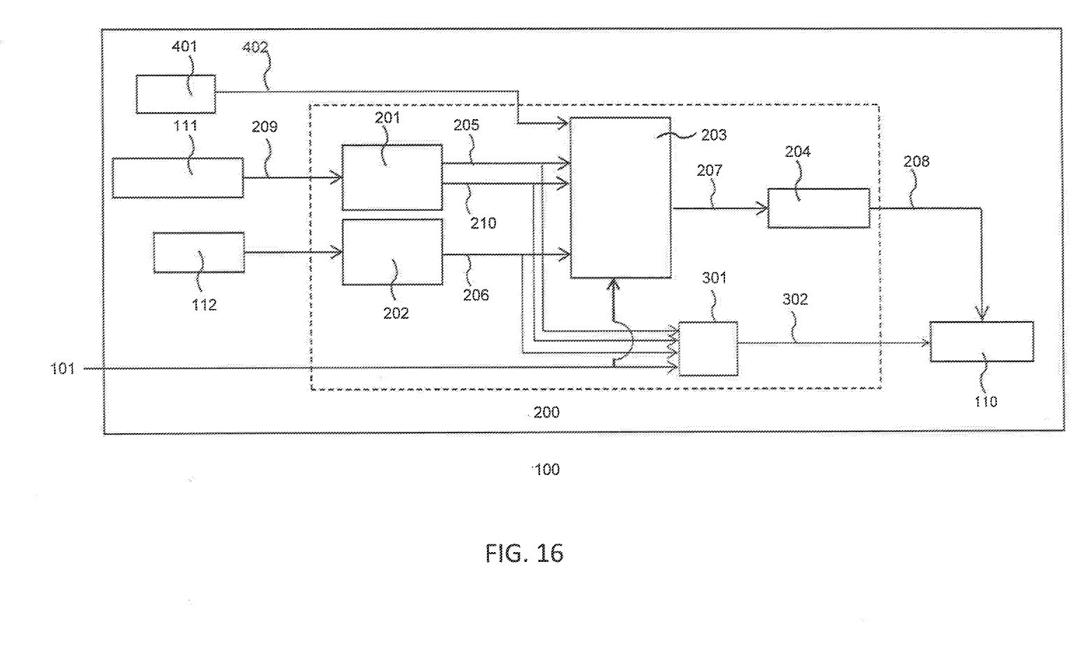

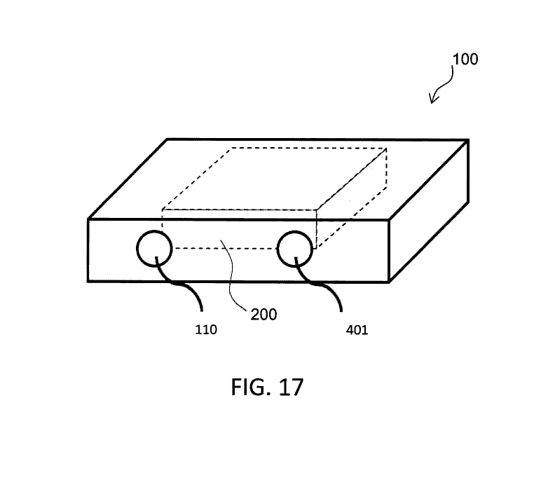

The internal parameter Aₚ and the external parameters Rₚ, and tₚ will be described in more detail. FIG. 7A and 7B are schematic plane diagrams along an XY-plane to explain the internal parameter Aₚ. FIG. 7A is a schematic plane diagram of an example of a lens and a display element which has a center being on a light axis of the lens. FIG. 7B is a diagram of a schematic plane view of an example of a lens and a display element which has a center not being on a light axis of the lens. FIG. 8 is a diagram of a coordinate system and external parameters Rₚ and tₚ.

In FIG. 7A and 7B, a distance Y between the light axis 121a of a lens 121 and an end portion 353a of an object 353, a distance y between the light axis 121a of the lens 121 and an end portion 133a of a projection image 133, a distance Z between the lens 121 and the object 353, and focal length f satisfy the following relation:

$$y = \frac{Y}{Z} f \qquad ( 8 )$$

In FIG. 7A, because the light axis 121a of a lens 121 passes through the center 131a of the display element 131, the following relation regarding the y-coordinate y′ of the projection image 133 on the display element 131 is satisfied:

y′=y (9)

Therefore the coordinate (cₓ, c_{y}) of the center 131a of the display element 131 for the light axis 121a of the lens 121 is (0, 0). That is, cₓ=0 and c_{y}=0. On the other hand, in FIG. 7B, the light axis 121a of a lens 121 and the center 131a of the display element 131 are misaligned along the y direction. Therefore, the following relation regarding the y-coordinate y′ of the projection image 133 on the display element 131 is satisfied:

y′=y+c_{y} (10)

The y-coordinate c_{y} of the center 131a of the display element 131 for the light axis 121a of the lens 121 is not 0. That is, c_{y} may be a value other than 0 that depends on the position of the light axis 121a of the lens 121 and the center 131a of the display element 131. In the case where the light axis 121a of the lens 121 and the center 131a of the display element 131 are misaligned along the x direction, the x-coordinate cₓ of the center 131a of the display element 131 internal parameter Aₚ is represented as follows:

$${A}_{p} = [ \begin{matrix}{f}_{x} & 0 & {c}_{x} \\ 0 & {f}_{y} & {c}_{y} \\ 0 & 0 & 1\end{matrix} ] \qquad ( 11 )$$

where fₓ and f_{y} in the relation (11) represent the focal lengths of the lens 121 for each pixels. As described in relation (11), the internal parameter Aₚ is a parameter defined based on the coordinate (cₓ, c_{y}) of the center 131a of the display element 131 and focal length fₓ, f_{y} of the lens 121 for each pixel.

The external parameter tₚ represents parallel translation of projection point. The matrix for the external parameters tₚ is a parallel translation matrix t which has the position of the projection point as the origin. The parallel translation matrix t is represented as follows:

$$t = ( \begin{matrix}{t}_{x} \\ {t}_{y} \\ {t}_{z}\end{matrix} ) \qquad ( 12 )$$

The external parameters R_{P} represents a projection direction of the projection unit 110. The matrix for the external parameters R_{P} is a rotation matrix R to translate a coordinate so that the vector V representing the projection direction is in a Z direction. The rotation matrix R is represented as follows:

$$R = ( \begin{matrix}{R}_{1} & {R}_{2} & {R}_{3} \\ {R}_{4} & {R}_{5} & {R}_{6} \\ {R}_{7} & {R}_{8} & {R}_{9}\end{matrix} ) \qquad ( 13 )$$

Therefore a matrix of external parameters [R_{P}, tₚ] is a matrix to translate a coordinate on the projection plane 351 represented by the world coordinate to a coordinate in a coordinate system which has a projection position as an origin and the projection direction as its Z axis. The rotation matrix Rₓ to rotate a coordinate (x, y, z) α degrees around a X axis is represented as follows:

$${R}_{x} = ( \begin{matrix}1 & 0 & 0 \\ 0 & cos α & sin α \\ 0 & sin α & cos α\end{matrix} ) \qquad ( 14 )$$

The rotation matrix R_{y} to rotate a coordinate (x, y, z) β degrees around a Y axis is represented as follows:

$${R}_{y} = ( \begin{matrix}cos β & 0 & sin β \\ 0 & 1 & 0 \\ - sin β & 0 & cos β\end{matrix} ) \qquad ( 15 )$$

The rotation matrix R_{z} to rotate a coordinate (x, y, z) Y degrees around a Z axis is represented as follows:

$${R}_{z} = ( \begin{matrix}cos γ & - sin γ & 0 \\ sin γ & cos γ & 0 \\ 0 & 0 & 1\end{matrix} ) \qquad ( 16 )$$

As described with respect to FIGS. 3-4, the shape acquiring unit 201 finds the shape information 205 of the projection plane 351. Points on the projection plane 351 have known coordinates. Therefore coordinates of pixels in the output image corresponding to the points on the projection plane 351 are found, with the relation (6).

A method to find a coordinate of a pixel in the observation image corresponding to a three dimensional coordinate of a point on the projection image 351 will now be described. A coordinate mₑ of a pixel in the observation image is defined as (xₑ, yₑ). A three dimensional coordinate M on the projection plane 351 corresponding to the coordinate mₑ is defined as (Xₛ, Yₛ, Zₛ), The relation between the coordinate mₑ and the three dimensional coordinate M is represented as follows:

\tilde{m}ₑ≅Pₑ·\tilde{M} (17)

The matrix Pₑ in the relation (17) is a perspective projection matrix for the image on the projection plane 351 observed from the position of the observation point acquired by the observation point acquiring unit 202. That is, the evaluating unit 203 transforms the perspective projection in the process of finding the coordinate of the pixel in the output image corresponding to the point of the three dimensional coordinate in the projection plane 351.

In this embodiment, the perspective projection Pₑis defined based on an internal parameter and an external parameter of the image unit because the projection plane 351 is observed from the observation point with the image unit like a camera. The internal parameter and the external parameter are similar to the internal parameter and the external parameters of the perspective projection Pₚ and may be acquired by preliminary calibration.

The corresponding relation between a coordinate (xₚ, yₚ) of a pixel in the input image and a coordinate (xₑ, yₑ) of a pixel in the observation image is acquired by acquiring the coordinate (xₚ, yₚ) of a pixel in the input image corresponding to a point on the projection plane 351 and the coordinate (xₑ, yₑ) of a pixel in the observation image corresponding to the point found with the relation (6) and (17). In FIG. 6B and 6C, the pixel 191 in the observation image 104 corresponds to the pixel 102 in the output image and the pixel 190 in the observation image 104 corresponds to the pixel 106 in the output image.

Therefore the relation between the output image and the observation image is represented with the relations (6) and (17). That is, the estimated image is acquired with reference to the output image and relations (6) and (17).

The case where the relation between a coordinate (xₚ, yₚ) of a pixel in the input image and a coordinate (xₑ, yₑ) of a pixel in the observation image is not acquired will be described with FIG. 9A and FIG. 9B. FIG. 9A is a schematic diagram of an example of a positional relationship between a projection plane, a projection point, and an observation point, in which the projection area includes convex and concave portions (that is, in which the projection area is nonplanar. FIG. 9B is a schematic diagram of an example of another positional relationship between a projection plane, a projection point, and an observation point.

The case where a relationship between the positions of the projection plane, the observation point and the projection point are illustrated in FIG. 9A and the coordinate (xₚ, yₚ) on the output image are projected onto the point (Xₛ, Yₛ, Zₛ) included in the projection area 505 will be described. The output image is projected onto the projection, area 504 in the projection plane 503. A part in the projection area 504, which is closer to the observation point 502, is convex toward the observation point relative to the other part in the projection area 504, which is farther from the observation point, so that the projection plane includes multiple planes.

When the projection plane 503 is observed from the observation point 502, the projection area 505 which is a part of the projection area 504 is in a shadow of the part in the projection area 504 which is closer to the observation point. The projection area 505 is an area between the convex portion and concave portion.

An image projected onto the point (Xₛ, Yₛ, Zₛ) in the projection area 505 is not observed from the observation point 502. Therefore the pixel in the observation image corresponding to the coordinate (xₚ, yₚ) of the pixel in the output image is not found. That is, there is a deficit in the image observed from the observation point 502.

The case where the coordinate (xₚ, yₚ) of the pixel in the output image is projected onto the point (Xₛ, Yₛ, Zₛ) which, is included in the projection area 508 are illustrated in FIG. 9B, The output image is projected onto the projection area 507 in the projection plane 506. In this example, distance sensor ill is not able to measure the distance between the distance sensor 111 and the point (X_{,}Yₛ, Zₛ) included in the projection area 508, which is a part of the projection area 507 for some reason.

For example, when the projection plane 506 includes a reflective or mirrored area, the distance sensor 111 may not be able to measure the distance between the distance sensor 111 and a mirrored area in the projection plane 506, since the light incident to the mirror area is reflected toward the projection unit 111a, rather than toward the receive unit 111b. As another example, when there is an area which has significantly low reflection ratio in the projection plane 506, sufficient light may not reach the receive unit 111b because the low reflection area may not reflect sufficient light from the projection unit 111a to the distance sensor. As described above, it may be difficult to measure the distance between the distance sensor 111 and the area which has significantly low reflection ratio.

In FIG. 9B, the relation between the point (Xₛ, Yₛ, Zₛ) and the coordinate (xₚ, yₚ) is not acquired because the Z-coordinate Zₛ is not measured. That is, the point on the projection plane onto which the coordinate (xₚ, yₚ) of the pixel ill the output image is not acquired. Therefore, regardless the position of observation point 502, there may be a deficit in the projected image relative to the output image and there may be a deficit in the observation image relative to the output image. There may be a deficit in the estimated image relative to the output image.

The evaluating unit 203 calculates shift amounts d for all corresponding pairs between the pixels (xₚ, yₚ) in the output image and the pixels (xₑ, yₑ) in the estimated image with relation (18).

d=(xₚ−xₑ)²+(yₚ−yₑ)² (18)

The total of the shift amounts d for the observation point is defined as error D. In the case where the area of observation point is used for the observation point information 206, the error D(i) for the area of observation point the is represented by relation (19). i is an index for each of the observation points in the area (1≦i≦L). L is a number of the points in the area of observation point and may be chosen arbitrarily, j is an index for each of the pixels in the output image (1≦i≦N). N is a number of pixels in the output image. i, j, L, and N are whole numbers.

$$D ( i ) = {\sum }_{j = 1}^{N} d ( i , j ) \qquad ( 19 )$$

In the case where there is no pixel (xₑ, yₑ) in the estimated image corresponding to the (xₚ, yₚ) in the output image, the shift amount d may be the predetermined maximum value dₘₐₓ for the shift amount d. In the case of FIG. 6, the maximum value dₘₐₓ may be, for example, the maximum length 8 (=2²+2²) between two points in the XY-coordinate system. The maximum, value among the errors D(i) for each of the observation points in the observation area may be a representative error Dₒᵤₜ for the area. The minimum value among the errors D(i) for each of the observation points in the observation area may be a representative error Dₒᵤₜ for the area.

The average among the errors D( i) for each of the observation points in the observation area may be a representative error Dₒᵤₜ for the area.

Dₒᵤₜ=max(D(i)) (20)

The evaluating unit 203 may, for example, calculate an appropriate level Rlv (the appropriate level 207) which represents how much the projection plane is appropriate for projection of an image with the relation (21) based on an error D(i) for the area of observation point and an reference error Dₜₕ which is a predetermined number representing the acceptable amount of an error.

$$Rlv = 1 - \frac{{D}_{out}}{{D}_{th}} \qquad ( 21 )$$

For example, the closer the appropriate level Rlv gets to 1, the more appropriate the projection plane is for projection. In the case where the maximum value among the errors D(i) for each of the observation points in the area of observation point is chosen as a representative error Dₒᵤₜ for the area of observation point, the appropriate level Rlv may be the minimum value. In the case where the minimum value among the errors D(i) for each of the observation points in the area of observation point is chosen as a representative error Dₒᵤₜ for the area of observation point, the appropriate level Rlv may be the maximum value. In the case where the average among the errors D(i) for each of the observation points in the area of observation point is chosen as a representative error Dₒᵤₜ for the area of observation point, the appropriate level Rlv is the average. The evaluating unit 203 transmits the appropriate level Rlv to the generating unit 204.

Other methods may be used to calculate the appropriate level 207. For example, the appropriate level 207 may represent the ratio of an area which includes neither a deficit nor a positional shift to the total area in the observation image. For example, in the case where the observation image includes neither a deficit nor a positional shift, the appropriate level 207 may be 100 percent. The appropriate level 207 may be represented as rank.

The generating unit 204 generates the auxiliary information data 208 to be provided for a user based on the appropriate level Rlv (S203).

The projection unit 110 projects the output image including the auxiliary information onto the projection image (S204).

Examples of the output image including the auxiliary information are illustrated in FIGS. 10A-10E. In FIG. 10A, a window 601 for the auxiliary information may be in upper right in the output image and a value of the appropriate level 207 is in the window. The appropriate level 207 may be displayed in other ways. As illustrated in FIG. 10C, 10D, and 10E, the appropriate level 207 may be displayed with a diagram of an indicator. As illustrated in FIG. 10B, in one case where the appropriate level 207 is not high, the auxiliary information may include information indicating to the user that the projection plane should be changed, in addition to the value of the appropriate level 207.

The auxiliary information may not be a part of image information. In the case of the image projection apparatus 100 comprise a sound generating unit, the sound generating unit may generate sound based on the appropriate level 207 included in the auxiliary information transmitted from the generating unit 204.

After the projection plane is decided as described above, the input image data 101 is input to the generating unit 204, transmitted to the projection unit 110, and an output image is generated by the projection unit 110. This output image does not include the auxiliary information. The output image is projected onto the projection plane by the projection unit 110. The projected image on the projection plane includes less deficit and positional shift and is same or similar to the output image in the case where the projected image is observed from the observation point.

By this embodiment, it is easy to determine whether the projection plane is appropriate for a projection to the arbitrary observation point. By this embodiment, it is easy for a user to determine whether the projection setting, which includes the position of the projection unit 110, direction of the projection unit, projection plane, and the position of the observation point, is appropriate or should be changed.

### Second Embodiment

The second embodiment will now be described. In this embodiment, the appropriate levels 207 will be generated for small regions in the projection plane. The evaluating unit 203 evaluates the appropriate levels 207 for small regions and transmits the appropriate levels 207 to the generating unit 204. Each of the appropriate levels 207 indicates how much the small regions in the projection plane onto which the output image is projected are appropriate. Each of the appropriate levels 207 may indicate whether the area in the projection plane is appropriate or not. Detail of the evaluating unit 203 and the generating unit 204 will be described.

An example of output image including a plurality of small regions is illustrated in FIG. 11. The number of the small regions is defined as M. M is an arbitrarily chosen whole number. The evaluating unit 203 finds the relation between the pixels in the small regions and the pixels in the estimated image corresponding to the each pixel in the small regions. For example, the evaluating unit 203 finds a pixel (xₑ, yₑ) in the estimated image corresponding to the coordinates (xₚ, yₚ) in the jth small region j and calculate the shift amount d. The number j is a whole number and satisfies the relation 1≦j≦M. In the case where the number of the pixels included in the output image is N and the number of the pixels in each of the small regions is equal, the number of pixels in one small region is N/M, where N is a whole number. In the jth small region, a plurality of shift amounts a for each of the pixels is calculated. The total of the plurality of shift amounts d is defined as an error D(I, j) for the small region j and the position of observation point i.

In the case where there is no pixel (xₑ, yₑ) in the estimated image corresponding to the (xₚ, yₚ) in the output image, the shift amount d may be the predetermined maximum, value dₘₐₓ for the shift amount d. In the case where the observation point information 206 encompasses an observation area, the errors D(I, j) for each of the plurality of the observation points and the position of observation points are calculated. The maximum value among the calculated errors D(I, j) may be the representative error Dₒᵤₜ(j) for the area of observation point.

Dₒᵤₜ(j)=max(D(i, j)) (22)

The error D for the small region j (or Dₒᵤₜ (j)) may be acquired in this way.

The evaluating unit 203 evaluates the appropriate level Rlv(j) (the appropriate level 207) which indicates how appropriate the projection plane is for projecting an image with the relation (23) based on the representative errors D for each small region (or Dₒᵤₜ(j)) a reference error Dₜₕ. The reference error Dₜₕ is a predetermined number representing the acceptable amount of an error. The appropriate level Rlv(j) is calculated for each small region as follows:

$$Rlv ( j ) = 1 - \frac{{D}_{out} ( j )}{{D}_{th}} \qquad ( 23 )$$

The evaluating unit 203 transmits a plurality of the appropriate levels Rlv(j) to the generating unit 204,

The generating unit 204 generates the auxiliary information data 208 based on the appropriate levels Rlv(j). The projection unit 110 may, for example, generate the output image including an image based on the input image data 101 and the auxiliary information data 208.

Examples of the output image of this embodiment are illustrated in FIG. 12A and 12B. FIG. 12A is an example of the output image which includes the appropriate levels for each of the small regions on the projection plane overlapped on an image based on the input image data 101. The plurality of the appropriate levels for the plurality of the small regions may be displayed. In the case where the appropriate levels for some adjacent small regions are the same or close to the same, the average of the appropriate levels may be displayed for such adjacent small regions.

In the case where a region in the projection plane has a relatively high appropriate level, the auxiliary information may include information to indicate that a direction to the region is an appropriate projection direction, as shown in FIG. 12B. An area around this region has a high possibility to nave totally higher appropriate level than the total appropriate level of the original area. The auxiliary information may include information indicating that a direction to a region is not an appropriate projection direction, for example, in the case where a region in the projection plane has low appropriate level.

By this embodiment, it is easy to determine whether the projection plane is appropriate for a projection to an arbitrary observation point. By this embodiment, it is easy for a user to determine whether the projection setting, which includes the position of the projection unit 110, direction of the projection unit, projection plane, and the position of the observation point, is appropriate or should be changed.

### Third Embodiment

The third embodiment will now be described. In this embodiment, the image projection apparatus 100 further includes a correction unit 301 to generate a correction image data 302 based on the shape information 205, the observation point, information 206, and the projection point information 210. The correction image data 302 is a corrected input image data 101. The evaluating unit 203 evaluates the appropriate level 207 for the correction image data 302 to be projected onto the projection plane by the projection unit 110.

Processing of the correction unit 301 will be described first. Generally, in the case where an image projected by the projection unit 110 is observed, as long as the projection point and the observation image are not same, the observation image gets distorted relative to the output image. The correction unit 301 corrects the input image data 101 and generates the correction image data 302 so that the observation image does not get distorted relative to the output image.

The distortion of an image on the projection plane will be described with FIG. 13A and 13E. FIG. 13A and 13B are schematic diagrams of examples of a positional relationship between a projection unit, an imaging apparatus, and a projection plane.

As described in FIG. 13A, the projection unit 110 projects a first image on projection plane 351 and an image apparatus 370 takes the first image as second image (observation image). A coordinate of a pixel in the first image is defined as mₚ. A three dimensional coordinate on the projection plane 351 corresponding to the coordinate mₚ is defined as M. A coordinate of a pixel in the second image corresponding to the three dimensional coordinate M is defined as m_{c1}. The relation between the coordinate mₚ and the coordinate m_{c1} is calculated by relation (24).

\tilde{m}_{c1}≅P_{C}·P_{P}⁻¹·\tilde{m}_{P} (24)

As described in FIG. 13B, the virtual case where the third image is projected on projection plane 351 from the position of the image apparatus 370 and the third image is taken as a forth image (observation image) from the position of the projection unit 110 will now be considered. A coordinate of a pixel in the fourth image corresponding to a coordinate mₚ of a pixel in the third image is defined as m_{c2}. The relation between the coordinate mₚ and the coordinate m_{c2} is calculated by relation (25).

\tilde{m}_{c2}≅P_{P}·P_{C}⁻¹·\tilde{m}_{P} (25)

It is found that the relation between the distortion of the second image relative to the first image and the distortion of the fourth image relative to the third image is a predistortion. Therefore, as represented in the relation (26), in the case where the fourth image is projected from the position of the projection unit 110 and the fourth image is observed from the position of the image apparatus 370, the distortion is cancelled. That is, the distortion in the observation image is suppressed.

\tilde{m}_{c1}≅P_{C}·P_{P}⁻¹·(P_{P}·P_{C}⁻¹·\tilde{m}_{P})≅\tilde{m}_{P} (26)

The information processing device 200 of this embodiment will be described based on the relations represented above. FIG. 14 is a block diagram of an image projection apparatus according to this embodiment. FIG. 15 is a flow chart of an information processing method according to the third embodiment. The step S211 in FIG. 15 is same as the step 201 in FIG. 2.

The image projection apparatus 100 in this embodiment projects a correction image and an image in which a distortion is suppressed in the case where the image is observed from the reference observation point. The correction unit 301 generates the correction image data 302 from the input linage data 101 and transmits the correction image data 302 to the projection unit 110 (S212).

The evaluating unit 203 evaluates a positional shift of pixels and a deficit (information regarding a distortion and/or deficit) in the observation image relative to the output image and calculates the appropriate level 207 of the projection plane. The correction image is shaped so as not to nave a positional shift of pixels and not to have a deficit relative to the input image, in the case where the correction image is observed from the reference observation point.

As illustrated in FIG. 9, the observation image has a possibility to have deficits relative to the output image depending on the relationship between the shape of the projection plane, the position of the observation point, and the position of the projection point. Therefore, whatever the output image is, the deficit in the observation image observed from the reference observation point is analyzed. For example, pixels in the observation image corresponding to the pixels in the output image may be found with the relation (6) and (17). A pixel in the output image which has no corresponding pixel in the observation image is defined as a deficit. The deficit pixel is given the predetermined value dₘₐₓ as its shift amount. From above, regardless of the output image, the deficit is analyzed. The total value of shift amount dₘₐₓ for the deficit pixels is defined as deficit information D1.

The evaluating unit 203 further evaluates a positional shift of pixels and a deficit (information of a distortion and/or a deficit) in the observation image relative to the output image in the case where the observation image is observed from the observing point other than the reference observation point.

In the case where the observation point information 206 acquired by the observation point acquiring unit 202 includes the reference observation point, rather than the observation point, the appropriate level 207 is calculated based on the first evaluate information which indicates information of a distortion and a deficit of the reference observing point. In the case where the observation point information 206 is an observation area, the appropriate level 207 is calculated based on the evaluation of other information which indicates information of a distortion and a deficit of each of the reference observation points in the area.

In this embodiment, the information of a distortion and a deficit for the observing point other than the reference observing point is acquired by estimating a distortion and a deficit in the observation image relative to the output image which is caused in the virtual case where the output image is projected from, the reference observing position and the projected, output image is observed from the observation point. Based on this, the information of a distortion and a deficit is estimated with relation (22) for a plurality of the observation points other than the reference observation point. Among the acquired information of a distortion and a deficit, the maximum value is defined as distortion information D2.

The evaluation unit 203 finds the sum of deficit information D1 and distortion information D2 as an amount of deficit and distortion Dₒᵤₜ and calculates the appropriate level Rlv with relation (23) and the amount of deficit and distortion Dₒᵤₜ (S213). In the case where the observation point information 206 includes information of an observing point, the amount of deficit and distortion Dₒᵤₜ may be deficit information D1. In the case where the observation point information 206 includes an observation area, the amount of deficit and distortion Dₒᵤₜ may be distortion information D2. In this case, it is supposed that there is no deficit in the observation image observed from the reference observation point.

As described above, the evaluating unit 203 transfers the appropriate level 207 to the generation unit 204. The generation unit 204 generates the auxiliary information data 208 as described in first and second embodiments and transfers the auxiliary information data 208 to the projection unit 110 (S214). The projection unit 110 projects the auxiliary information onto the projection plane. The projection unit 110 may project the auxiliary information with the correction image onto the projection plane (S215).

By this embodiment, it is easy to determine whether the projection plane is appropriate for a projection to the arbitral observation point. By this embodiment, it is easy for a user to determine whether the projection setting, which is the position of the projection unit 110, direction of the projection unit, projection plane, and the position of the observation point, is appropriate or should be changed.

### Fourth Embodiment

The fourth embodiment will now be described. In particular, the differences between the first embodiment and this embodiment will be described. In this embodiment, the image projection apparatus 100 further comprises an image unit 401 to image the projection plane and the evaluation unit 203 evaluates the appropriate level 207 based on not only the information of deficit and distortion but also optical information of the projection plane. FIG. 16 is a block diagram of the image projection apparatus according to the fourth embodiment.

In FIG. 16, the image projection apparatus is the image projection apparatus in the third embodiment with the image unit 401.

The details of the image unit 401 and the estimation unit 203 will now be described with reference to FIG. 17, which is a schematic prospective diagram of an image projection apparatus according to the fourth embodiment. As illustrated in FIG. 17, the image unit 401 may be, for example, attached to the projection unit 110 and take an image of the projection plane on which an image is projected by the projection unit 110. The image unit 401 may take a pattern image that the whole is white and is projected onto the projection plane by the projection unit 110. The image unit 401 transmits image information 402 regarding the area including the pattern image on the projection plane acquired by taking of the pattern image.

The evaluation unit 203 finds the information of deficit and distortion and optical information of the projection plane based on the shape information 205, the observation point information 206, the projection point information 210, and image information 402. The evaluation unit 203 finds the representative error Dₒᵤₜ of the information of deficit and distortion in the same manner as described above with respect to the first embodiment with the relation (18) through (20). The evaluation unit 203 finds the relation between the coordinate mc of a pixel in the image taken by the image unit 401 and the three dimensional coordinate in the projection plane.

\tilde{m}_{C}≅P_{C}·\tilde{M} (27)

where P_{c} is a perspective projection matrix.

In this embodiment, calibration of the image unit 401 is done and the internal parameter, the external parameters, and the perspective projection matrix P_{c} are found before taking an image. The coordinate (xₚ, yₚ) of a pixel mₚ corresponding to the coordinate (x_{c}, y_{c}) of a pixel m_{c} is acquired with relation (6) and (27), and the pixel value C(x_{c}, y_{c}) of a pixel mc and the pixel value P(xₚ, yₚ) of a pixel mP is calculated. The difference between the pixel value C(x_{c}, y_{c}) of a pixel m_{c} and the pixel value P(xₚ, yₚ) of a pixel mₚ is defined as C(=|C(x_{c}, y_{c})−P(xₚ, yₚ)|). The differences C for all of the pixels in the input image are calculated. The sum of the differences C is defined as an error or the optical information Cₒᵤₜ.

The error or the optical information Cₒᵤₜ indicates the sum of the differences between pixel values in the pattern image and pixel values in the image taken by the image unit 401 corresponding to the pixel in the pattern image. Therefore, in the case where the color of the projection image is white, the value of the error of the optical information Cₒᵤₜ is more likely small. In the case where the color of the projection image is not white or has a pattern, the error or the optical information Cₒᵤₜ is more likely large. The evaluating unit 203 calculates the optically appropriate level RlvC based on the optical information Cₒᵤₜ. The value Cₜₕ is a predetermined acceptable upper value of the optical error.

RlvC=1−Cₒᵤₜ/Cₜₕ (28)

The optically appropriate level Rlv defined on relation (21) is defined as an appropriate level of a shape RlvD. The final appropriate level Rlv (the final appropriate level 207) of the projection plane is calculated by blending the optically appropriate level RlvC and the appropriate level of a shape RlvD with a weight α as represented in the relation (29). The final appropriate level Rlv is calculated by adjusting the weight α based on a degree of influence on the image by the shape information and by the optical information.

Rlv=α·RlvC+(1−α)·RlvD (29)

The evaluating unit 203 transmits the final appropriate level Rlv as the appropriate level 207 to the generation unit 204. The generation unit generates the auxiliary information data 208 in the way described in first through third embodiments and transmits the auxiliary information data 208 to the projection unit 110. The projection unit 110 projects an image based on the auxiliary information. The projection unit 110 may project an image based on the auxiliary information including the correction image.

By this embodiment, it is easy to determine whether the projection plane is appropriate for a projection to the arbitrary observation point. By this embodiment, it is easy for a user to determine whether the projection setting, which includes the position of the projection unit 110, direction of the projection unit, projection plane, and the position of the observation point, is appropriate or should be changed.

Each of the embodiments was described with specific examples. However, this disclosure is not limited to these specific examples. For example, one of ordinary skill in the art will understand that this disclosure may be implemented using available variations in the specific configuration of each element.

One of ordinary skill in the art will also understand that this disclosure may be implemented using combinations of two or more elements from the specific examples.

One of ordinary skill in the art will also understand that this disclosure may be implemented using other optical devices and image display apparatuses.

While certain embodiments have been described, these embodiments have been presented by way of example only, and are not intended to limit the scope of the disclosure. Indeed, the embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

1. An information processing device for a projection unit comprising:
a shape acquiring unit configured to acquire shape information regarding a projection plane onto which an image is projected by the projection unit and projection point information regarding a position of the projection unit;
an observation point acquiring unit configured to acquire observation point information, regarding an observation point to observe the projection plane;
an evaluating unit configured to evaluate an appropriate level of the projection plane based on the shape information, the projection point information, and the observation point information; and
a generating unit configured to generate an auxiliary information data based on the appropriate level.

2. The device according to the claim 1, wherein the evaluation unit estimates the appropriate level based on at least one of a positional shift and a deficit in an estimation image estimated to be observed from the observation point relative to an output image in the case where the output image is projected onto the projection plane from the projection unit.

3. The device according to the claim 1, wherein the observation point information is information regarding a plurality of observation points in an area.

4. The device according to the claim 3, wherein the evaluation unit finds a plurality of the appropriate levels for the plurality of the observation points, and the generation unit generates the auxiliary information data based on one of the appropriate level among the plurality of the appropriate levels.

5. The device according to the claim 3, wherein the evaluation unit finds a plurality of the appropriate levels for the plurality of the observation points, and the generation unit generates the auxiliary information data based on the average among the plurality of the appropriate levels.

6. The device according to the claim 1, wherein the evaluation unit finds the appropriate levels for a plurality of the small regions in the projection plane, and the generation unit generates the auxiliary information data for the plurality of the small regions.

7. The device according to the claim 1, further comprising a correction unit configured to be input an image data to generate an output image to be projected onto the projection data, and configured to generate correction image data which is a corrected data of the image data based on the shape information, the projection point information, and the observation point information.

8. The device according to the claim 1, further comprising an image unit configured to image the projection plane, and
wherein the evaluating unit finds the appropriate level based on at least one of a positional shift and a deficit in an estimation image estimated to be observed from the observation point relative to an output image in the case where the output image is projected onto the projection plane from the projection unit, and a deficit in an image taken by the image unit to an output image.

9. A projection apparatus comprising:
a projection unit; and
an information processing device connected to the projection unit comprising:
a shape acquiring unit configured to acquire shape information regarding a projection plane onto which an image is projected by the projection unit and projection point information regarding a position of the projection unit;
an observation point, acquiring unit configured to acquire observation point information regarding an observation point to observe the projection plane;
an evaluating unit configured to evaluate an appropriate level of the projection plane based on the shape information, the projection point information, and the observation point information; and
a generating unit configured to generate an auxiliary information data based on the appropriate level.

10. An information processing device connected to a projection unit comprising:
an evaluating unit configured to evaluate an appropriate level of the projection plane based on a shape information regarding a projection plane onto which an image is projected by the projection unit, a projection point information regarding a position of the projection unit, and an observation point information regarding an observation point to observe the projection plane; and
generating unit configured to generate an auxiliary information data based on the appropriate level.

11. The device according to the claim 10, the evaluation unit estimates the appropriate level based on at least one of a positional shift and a deficit in an estimation image estimated to be observed from the observation point relative to an output image in the case where the output image is projected onto the projection plane from the projection unit.

12. The device according to the claim 10, wherein the observation point information is information regarding a plurality of observation points in an area.

13. The device according to the claim 12, wherein the evaluation unit finds a plurality of the appropriate levels for the plurality of the observation points, and the generation unit generates the auxiliary information data based on the minimum appropriate level among the plurality of the appropriate levels.

14. The device according to the claim 12, wherein the evaluation unit finds a plurality of the appropriate levels for the plurality of the observation points, and the generation unit generates the auxiliary information data based on the average among the plurality of the appropriate levels.

15. The device according to the claim 10, wherein the evaluation unit finds the appropriate levels for a plurality of the small regions in the projection plane, and the generation unit generates the auxiliary information data for the plurality of the small regions.

16. The device according to the claim 10, further comprising a correction unit configured to be input an image data to generate an output image to be projected onto the projection data, and configured to generate correction image data which is a corrected data of the image data based on the shape information, the projection point information, and the observation point information.

17. The device according to the claim 10, further comprising an image unit configured to image the projection plane, and
wherein the evaluating unit finds the appropriate level based on at least one of a positional shift and a deficit in an estimation image estimated to be observed from the observation point relative to an output image in the case where the output image is projected onto the projection plane from the projection unit, and a deficit in an image taken by the image unit to an output image.

18. A projection apparatus comprising:
a projection unit; and
an information processing device connected to the projection unit comprising:
an evaluating unit configured to evaluate an appropriate level of the projection plane based on a shape information regarding a projection plane onto which an image is projected by the projection unit, a projection point information regarding a position of the projection unit, and an observation point information regarding an observation point to observe the projection plane; and
a generating unit configured to generate an auxiliary information data based on the appropriate level.
